(19) United States
(12) Patent Application Publication
(10) Pub. No.: US 2015/0292940 A1
(43) Pub. Date: Oct. 15, 2015

(54) PHOTODETECTION APPARATUS

(71) Applicant: SHARP KABUSHIKI KAISHA, Osaka-shi, Osaka (JP)

(72) Inventor: Yukio Watanabe, Osaka-shi (JP)

(73) Assignee: SHARP KABUSHIKI KAISHA, Osaka-shi, Osaka (JP)

(21) Appl. No.: 14/437,871

(22) PCT Filed: Aug. 22, 2013
(86) PCT No.: PCT/JP2013/072386

§ 371 Date: Apr. 23, 2015

(30) Foreign Application Priority Data
Nov. 8, 2012 (JP) 2012-246605

(51) Int. Cl. G01J 1/04; G01N 21/64

(52) U.S. Cl. CPC G01J 1/0411; G01J 1/0488; G01N 21/6456; G01N 21/6486; G01N 2201/06113; G01N 2201/10; G01N 2201/0638

(57) ABSTRACT

A photodetection apparatus includes an objective lens element (17) that collects light from a measurement object (16) and a photodetection element that detects the light collected by the objective lens element (17). The objective lens element (17) includes a center portion (28) that collects the light through refraction and a peripheral portion (29) located around the center portion (28) that collects the light through reflection. Thus, light at a large emission angle which may not be collected in a normal convex lens can also be collected, and thus collecting efficiency can be improved and the sensitivity of the photodetection element can be increased.

### TECHNICAL FIELD

The present invention relates to a photodetection apparatus reading two-dimensionally distributed fluorescent labels or the like.

### BACKGROUND ART

In the related art, fluorescence detection systems using fluorescent pigments as labeled substances have been widely used in the fields of biochemistry and molecular biology. The fluorescence detection systems can be used to perform, for example, gene arrangement, analysis of gene mutation and polymorphism, and evaluation of protein separation and identification and are thus used to develop drugs and the like.

As an evaluation method using fluorescent labeling, as described above, a method of distributing biological compounds such as proteins in gels through electrophoresis and acquiring the distributions of the biological compounds through fluorescence detection is well used. In the electrophoresis, an electric field gradient is generated in a solution such as a buffer solution by putting an electrode in the solution and causing a direct current to flow. At this time, when protein, Deoxyribonucleic acid (DNA), or ribonucleic acid (RNA) with a charge is present in the solution, molecules with a positive charge can be attracted to an anode and molecules with a negative charge can be attracted to a cathode. Thus, separation of the biological molecules can be performed.

Two-dimensional electrophoresis which is one of the evaluation methods using the foregoing electrophoresis is an evaluation method in which biomolecules are distributed in a gel two-dimensionally by combining two types of electrophoresis methods, and is considered to be the most effective method available to perform proteome analysis.

As a combination of the two types of electrophoresis methods, for example, a combination of “isoelectric point electrophoresis using a difference in an isoelectric point of the individual protein” which is the first dimension and “sodium dodecylsulfate polyacrylamide gel electrophoresis (SDS-PAGE) performing separation with the molecular weight of the protein” which is the second dimension is generally used. Fluorescence pigments are added to proteins, which are biomolecules separated in this way, before electrophoresis is performed or after electrophoresis is performed.

Image reading devices that emit excitation light to a gel support in which biomolecules (proteins) are distributed two-dimensionally, the gel support being produced in the above manner, acquire generated fluorescence intensities, and display fluorescence distribution (protein distribution) images based on the fluorescence intensities are widely used in the fields of biochemistry and molecular biology.

As a method of maintaining a two-dimensional distribution of the biomolecules, a method of separating proteins in the gel and subsequently transferring the proteins from the gel to a membrane using electrophoresis or capillarity as well as maintaining the distribution of the biomolecules in the gel can be performed. In this case, as in the case of image reading performed using the gel support, the fluorescence distribution of a transfer support which is the membrane can be imaged by an image reading device.

As an image reading device reading a biomolecule distribution image from a gel support or a transfer support in which the biomolecules are distributed two-dimensionally, as described above, there is an image reading device disclosed in Japanese Unexamined Patent Application Publication No. 10-3134 (PTL 1).

In the image reading device of the related art, a mirror in which a hole is formed in a center portion thereof is mounted on an optical head moving in a main scanning direction. Laser light (excitation light) with a wavelength corresponding to the wavelength of a fluorescent substance from a light source is caused to pass through the hole of the mirror to irradiate the transfer support in which electrophoresis of denatured DNA labeled by the fluorescent substance is recorded. Then, the fluorescence being emitted through excitation of fluorescent pigments in the transfer support is reflected to the periphery of the hole of the mirror, is subjected to photoelectric conversion by a multiplier, and is detected. In this way, image data corresponding to one line is stored in a line buffer. Subsequently, a two-dimensional visible image (fluorescent image) is obtained by an image processing device by repeating the foregoing operation while moving the optical head in a sub-scanning direction perpendicular to the main scanning direction.

As described above, in the image reading apparatus of the related art, the transfer support is irradiated with the excitation light without using a dichroic mirror. Therefore, stronger excitation energy can be given to the transfer support than when performing a method of irradiating with the excitation light through a dichroic mirror, and thus the S/N of a photoelectrically detected signal (image information) can be improved.

However, a further improvement of the S/N is required in order to detect weak fluorescence.

In order to improve the S/N of the photoelectrically detected signal (image information), it is necessary to collect as much as possible the fluorescence being emitted and spreading isotropically as a result of excitation of the fluorescent pigments due to irradiation with the excitation light such as laser light.

Here, as a method of collecting the fluorescence emitted at a wide angle as efficiently as possible, there is a method that involves using an objective lens with a high NA (numerical aperture), however, the lens element ends up being large.

In this case, the sizes of optical elements such as a reflective mirror, a laser light cut-off filter, a collecting lens, and the like which are installed to guide the fluorescence up to the multiplier increase together with the increase in the size of the objective lens collecting the fluorescence. Therefore, in the image reading device scanning an optical system including an optical head, there is a problem in that the size of the whole device is increased with the increase in the size of the optical element and scanning may not be performed at a high speed.

### CITATION LIST

### Patent Literature

PTL 1: Japanese Unexamined Patent Application Publication No. 10-3134

### SUMMARY OF INVENTION

### Technical Problem

Accordingly, a task of the invention is to provide a photodetection apparatus capable of improving light-collecting efficiency while reducing the size of an objective lens.

### Solution to Problem

In order to resolve the problems, a photodetection apparatus of the invention includes: an objective lens element that collects light from a measurement object; and a photodetection element that detects the light collected by the objective lens element. The objective lens element includes a center portion that collects the light through refraction and a peripheral portion located around the center portion to collect the light through reflection.

In the photodetection apparatus according to an embodiment, the light from the measurement object may be light that is radially emitted from substantially one point on the measurement object. The objective lens element may collect the light that is radially emitted from the substantially one point on the measurement object to the photodetection element.

The photodetection apparatus according to an embodiment may further include a light source that irradiates the measurement object with light. The objective lens element may include a light transmission portion that transmits the light from the light source. The light from the light source is made to pass through the light transmission portion of the objective lens element so as to irradiate the measurement object.

In the photodetection apparatus according to an embodiment, the objective lens element may have a shape concentric with an optical axis. The optical axis may pass through at least a part of the light transmission portion.

The photodetection apparatus according to an embodiment may further include a wavelength filter that is located between the objective lens element and the photodetection element and reduces light with substantially the same wavelength as the wavelength of the light from the light source. The wavelength filter may reduce a light component with substantially the same wavelength as the wavelength of the light from the light source among the light collected by the objective lens element and irradiates the photodetection element with the light.

The photodetection apparatus according to an embodiment may further include an intermediate lens element that is located between the objective lens element and the photodetection element. The intermediate lens element may further collect the light collected by the objective lens element to the photodetection element.

In the photodetection apparatus according to an embodiment, the center portion of the objective lens element may include an incident side convex surface on which the light from the measurement object is incident and which has a convex curved surface shape toward an outside in an optical axis direction, and an exit side convex surface from which the light from the incident side convex surface is emitted and which has a convex curved surface shape toward the outside in the optical axis direction. The peripheral portion of the objective lens element may include an incident side end surface on which the light from the measurement object is incident, an outer circumferential surface that internally reflects the light from the incident side end surface, and an exit side end surface from which the light internally reflected by the outer circumferential surface is emitted. A concave boundary portion may be formed at a boundary between the incident side convex surface in the center portion and the incident side end surface in the peripheral portion.

The “internal reflection” mentioned here is a concept also including total reflection.

In the photodetection apparatus according to an embodiment, the incident side convex surface in the center portion and the incident side end surface in the peripheral portion in the objective lens element may have a shape such that an optical path of the light incident from the incident side convex surface and an optical path of the light incident from the incident side end surface are separated from each other by the concave boundary portion and do not intersect each other.

In the photodetection apparatus according to an embodiment, the incident side end surface in the peripheral portion of the objective lens element may have a convex curved surface shape toward the outside.

In the photodetection apparatus according to an embodiment, the outer circumferential surface in the peripheral portion of the objective lens element may have a convex curved surface shape toward the outside.

### Advantageous Effects of Invention

As is apparent from the above description, in the photodetection apparatus of the invention, the objective lens element that collects the light from the measurement object includes the peripheral portion that collects the light through reflection in the outer circumference of the center portion corresponding to a normal convex lens collecting light through refraction. Accordingly, light at a large emission angle which may not be collected in a normal convex lens can also be collected, and thus collecting efficiency can be improved and the sensitivity of the photodetection element can be increased. Therefore, in order to improve the S/N of a photoelectrically detected signal (image information), the diameter of the objective lens element can be reduced more than when a convex lens with the same NA as that of the objective lens element is used as an objective lens.

Since the objective lens element collects the light from the measurement object and the light is incident on the photodetection element, the diameters of the optical elements and the photodetection element downstream of the objective lens element can be reduced, and thus a detection optical system can be configured compactly so that scanning can be performed at a high speed.

### BRIEF DESCRIPTION OF DRAWINGS

FIG. 1 is a diagram illustrating the outer appearance of a photodetection apparatus of the invention.

FIG. 2 is a diagram illustrating the outer appearance of a scanning stage installed below a sample table in FIG. 1.

FIG. 3 is a sectional view illustrating a scanning module mounted on a second stage in FIG. 2.

FIG. 4 is a sectional view illustrating an objective lens in FIG. 3.

FIG. 5 is a diagram illustrating an example of a specific shape of the objective lens.

FIG. 6 is a diagram illustrating beams of light from the objective lens to a pinhole in FIG. 3.

FIG. 7 is a sectional view illustrating a collimator lens of the related art.

### DESCRIPTION OF EMBODIMENTS

Hereinafter, the invention will be described in detail with reference to the drawings according to an embodiment.

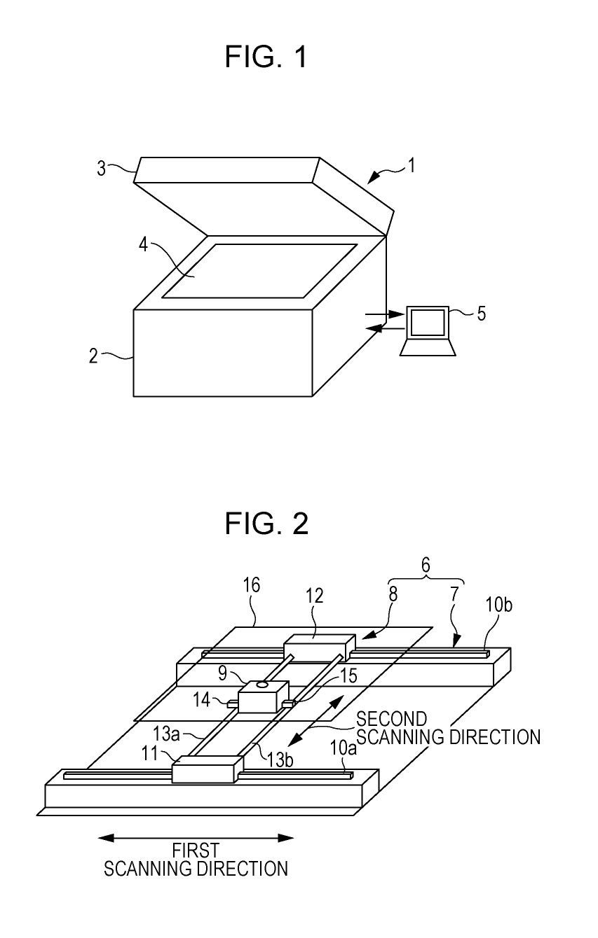

FIG. 1 is a diagram illustrating the outer appearance of a photodetection apparatus of an embodiment. A photodetection apparatus 1 is basically configured to include a body 2 that forms a casing and a lid 3 that covers the upper surface of the body 2. A sample table 4 formed of glass is provided on the upper surface of the body 2. For example, a gel support or a transfer support such as a membrane (none of which is illustrated) in which an organism-derived substance labeled with a fluorescent substance is distributed is set as a sample on the sample table 4.

An optical system is disposed on the lower side of the sample table 4. The sample set on the sample table 4 is irradiated from below with excitation light through the sample table 4 by a light irradiation optical system, and then fluorescence coming from the sample and passing through the sample table 4 is detected by the detection optical system. The detection optical system is connected to an external terminal such as a personal computer (PC) 5 and is subjected to measurement condition control or the like by the PC 5. The PC 5 generates a fluorescence image of the sample based on detected data and displays the generated fluorescence image or the like on a built-in display screen.

FIG. 2 is a diagram illustrating the outer appearance of a scanning stage 6 installed below the sample table 4. The scanning stage 6 is configured to include a first stage 7 serving as a reference and a second stage 8 mounted on the first stage 7. A scanning module 9 is mounted on the second stage 8. The detection optical system detecting the fluorescence is stored in the scanning module 9.

Two guide rails 10a and 10b that extend in a first scanning direction and face each other at a uniform interval are arranged in the first stage 7 included in the scanning stage 6. The second stage 8 includes a first guide member 11 that is guided by the guide rail 10a of the first stage 7 and reciprocates in the first scanning direction and a second guide member 12 that is guided by the guide rail 10b and reciprocates in the first scanning direction.

Two guide rails 13a and 13b that extend in a second scanning direction perpendicular to the first scanning direction and face each other at a uniform interval are installed between the first guide member 11 and the second guide member 12 included in the second stage 8. The scanning module 9 includes a first guide member 14 that is guided by the guide rail 13a and reciprocates in the second scanning direction and a second guide member 15 that is guided by the guide rail 13b and reciprocates in the second scanning direction.

According to a scanning method performed by the scanning stage 6 with the foregoing configuration, the first guide member 11 and the second guide member 12 of the second stage 8 are first guided by the guide rails 10a and 10b to be moved in the first scanning direction so that the second stage 8 is positioned with respect to the first stage 7. Subsequently, the first guide member 14 and the second guide member 15 of the scanning module 9 are guided by the guide rails 13a and 13b to be moved in the second scanning direction so that the scanning module 9 is positioned with respect to the second stage 8. Thereafter, the foregoing operations are repeated to two-dimensionally scan a sample 16.

That is, in the embodiment, movement means in the first scanning direction is configured to include the guide rails 10a and 10b, the first guide member 11, and the second guide member 12 and movement means in the second scanning direction is configured to include the guide rails 13a and 13b, the first guide member 14, and the second guide member 15.

In a lower portion of the sample table 4 of the body 2 forming the casing, although detailed description is omitted, a scanning mechanism formed by a motor, driving belts, ball screws, gears, a control board, a power source, wirings, and the like is installed below the scanning stage 6 in order to move the first guide member 11 and the second guide member 12 of the second stage 8 in the first scanning direction and in order to move the first guide member 14 and the second guide member 15 of the scanning module 9 in the second scanning direction.

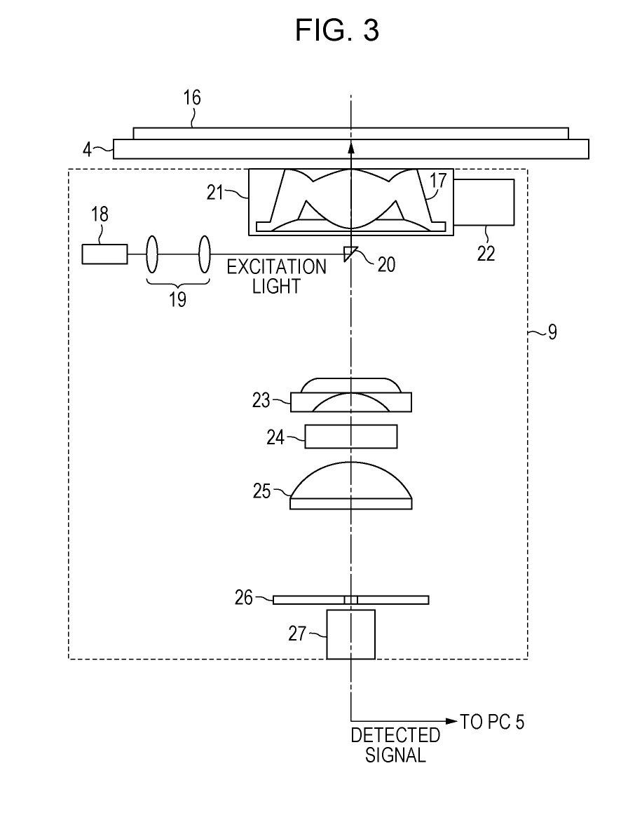

FIG. 3 is a longitudinal sectional view illustrating the schematic configuration of the scanning module 9 mounted on the second stage 8. In the following description, a case will be described in which weak fluorescence with a different wavelength from the excitation light arriving from the sample 16 which is the measurement object labeled with the fluorescence material is detected based on the irradiation with the excitation light from the light source 18.

In FIG. 3, an objective lens 17 that is the objective lens element which is located near the sample table (glass) 4 and which collects the fluorescence from the sample 16 set on the sample table 4 is disposed in an upper portion inside the scanning module 9. A reflective mirror 20 which reflects the excitation light such as laser light emitted from the light source 18 and collected by a lens group 19 formed by a plurality of lenses so that the excitation light is incident on the objective lens 17 is disposed at a position at which the optical axis of the objective lens 17 is perpendicular to the optical axis of the excitation light of a light source 18.

The objective lens 17 is accommodated inside a lens holder 21. The lens holder 21 is configured to be movable in an optical axis direction of the objective lens 17 by a driving unit 22 such as a stepping motor. Thus, the objective lens 17 is configured to be movable in the optical axis direction along with the lens holder 21.

On the lower side of the reflective mirror 20 on the optical axis of the objective lens 17, a first lens 23 that converts the fluorescence coming from the sample 16 and collected by the objective lens 17 into parallel light, a wavelength filter 24 that reduces the amount of excitation light, a second lens 25 that collects the fluorescence passing through the wavelength filter 24, and a pinhole 26 that reduces the amount of stray light of the fluorescence passing through the second lens 25 are disposed in this order from the side of the reflective mirror 20. A detector 27 which is a photodetection element detecting the fluorescence passing through the pinhole 26 is disposed on the lower side of the pinhole 26 on the optical axis of the objective lens 17.

In the scanning module 9 having the foregoing configuration, the excitation light emitted from the light source 18 is converged by the lens group 19, is subsequently reflected by the reflective mirror 20, passes through the objective lens 17 and the sample table 4, and is collected at one point on the lower surface of the sample 16. In this case, the length of the reflective mirror 20 in the longitudinal direction (which is a direction perpendicular to the optical axis of the lens group 19) of the reflective mirror 20 is short and the width of the reflective mirror 20 in the direction perpendicular to the longitudinal direction is narrow, and thus the excitation light from the light source 18 passes through only the neighborhood (an excitation light transmission portion) of the optical axis of the objective lens 17.

The fluorescence is emitted isotropically from substantially one point at which the sample 16 has been irradiated with the excitation light to the periphery. Then, a component of the emitted fluorescence which passes through the sample table 4 formed of glass and is incident on the objective lens 17 passes through the objective lens 17, the first lens 23, the wavelength filter 24, the second lens 25, and the pinhole 26 and is detected by the detector 27. A detected signal from the detector 27 is subjected to a process such as AD conversion by a built-in AD converter (not illustrated) or the like and is subsequently transmitted to the PC 5. In this way, a distribution of the fluorescence intensity at each measurement point on the sample 16 is recorded on an internal memory or the like.

Here, as described above, the fluorescence passing through the objective lens 17 is converted into converging light and is guided in the direction of the first lens 23. Then, the converging light is refracted by the first lens 23 so that the refracted light becomes light substantially parallel to the optical axis. The second lens 25 which is an intermediate lens element collects the fluorescence from the first lens 23. The pinhole 26 is disposed to reduce the amount of stray light spatially. The wavelength filter 24 that reduces the amount of the excitation light is disposed in, for example, a rotation folder (not illustrated) and is configured to be exchanged with a filter with a different wavelength according to the wavelength of the excitation light.

Hereinafter, details of the objective lens 17 which characterizes the present disclosure will be described.

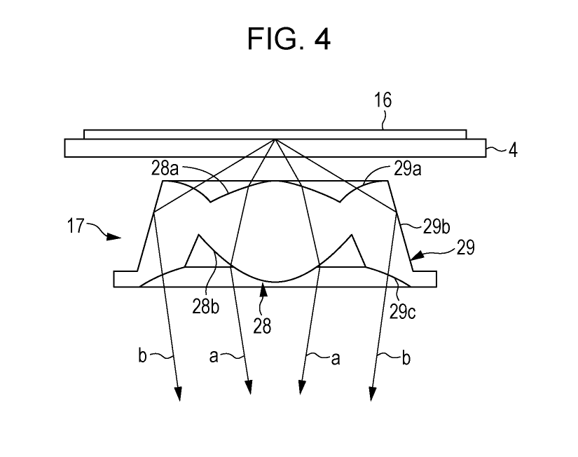

FIG. 4 is a longitudinal sectional view illustrating the objective lens 17. As understood from FIG. 4, a center portion including the optical axis of the objective lens 17 includes an incident side convex surface 28a and an exit side convex surface 28b protruding along the optical axis and is configured as a convex lens portion 28 having a function (of deflecting light only through refraction) of a normal convex lens. Of the fluorescence emitted from the sample 16, fluorescence a at a small emission angle passes through the portion of the convex lens portion 28 and is collected by the first lens 23. Hereinafter, the convex lens portion 28 is sometimes referred to as a “center portion”.

A peripheral portion of the exit side convex surface 28b (the convex lens portion 28) of the objective lens 17 is formed as a truncated conic cylindrical body 29 open downward. Of the fluorescence emitted from the sample 16, fluorescence b at a large emission angle which does not enter the convex lens portion 28 is incident on the cylindrical body 29 from an incident side end surface 29a of the cylindrical body 29, is totally reflected by an outer circumferential surface 29b continuous with the incident side end surface 29a so as to be deflected toward the optical axis side, and is emitted from an exit side end surface 29c indirectly continuous with the outer circumferential surface 29b to the first lens 23. Hereinafter, the cylindrical body 29 is sometimes referred to as a “peripheral portion”.

As described above, of the fluorescence emitted from the sample 16, the fluorescence at a large emission angle which does not enter the convex lens portion 28 is totally reflected by the outer circumferential surface 29b of the cylindrical body 29, so that light at a large emission angle which may not be collected by a normal convex lens can also be collected. Therefore, it is possible to increase the sensitivity of the detector 27.

It is possible to form the lens element compactly compared to a case of a normal convex lens in which the same NA as that of the objective lens 17 of the photodetection apparatus 1 is realized.

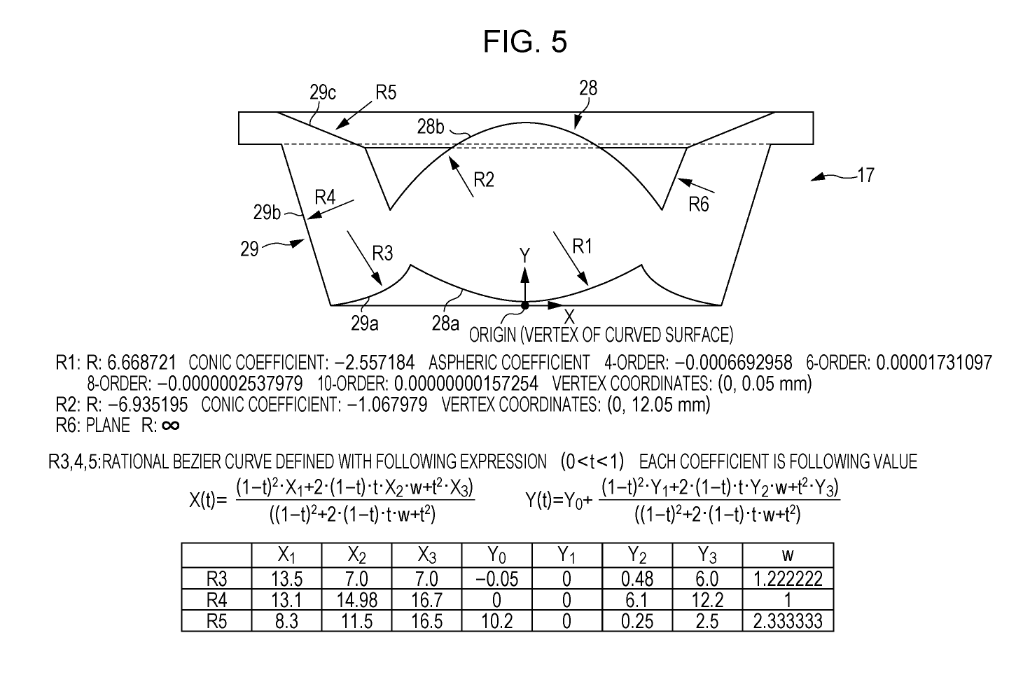

FIG. 5 is a diagram illustrating an example of a specific shape of the objective lens 17. The dimensions described in FIG. 5 are merely examples and the invention is not limited to the dimensions in FIG. 5. Here, “R” in FIG. 5 is a radius of curvature and is measured in units of “mm”. In FIG. 5, the foremost end of the incident side of the objective lens 17 on the optical axis is set as the origin. A direction vertical to the optical axis is taken as the X axis and a direction of the optical axis is taken as the Y axis. Accordingly, the origin is not an intersection point between the incident side convex surface 28a of the convex lens portion 28 and the optical axis, but is an intersection point between the optical axis and a plane including an intersection line of the incident side end surface 29a of the cylindrical body 29 and the outer circumferential surface 29b.

As described above, the fluorescence at a small emission angle among the fluorescence emitted from the sample 16 passes through the center portion (the convex lens portion 28) including the optical axis of the objective lens 17 and is collected toward the first lens 23. Thus, the center portion of the objective lens 17 has the shape of a convex lens in order to collect the light emitted radially from a point light source through refraction.

Here, a lens including a convex lens portion in its center portion and a cylindrical body having an outer circumferential surface reflecting incident light around the convex lens portion is disclosed in Domestic Re-publication of PCT International Publication for Patent Application No. WO2008/069143 or Japanese Unexamined Patent Application Publication No. 2010-114044. However, these patent literatures relate to lens for light emission elements emitting light forward from light-emitting elements such as LEDs with good directivity. The fact that a similar lens is used as an objective lens in a photodetection apparatus or the fact that an optical element of a photodetection apparatus is miniaturized using the lens as an objective lens was not disclosed or suggested.

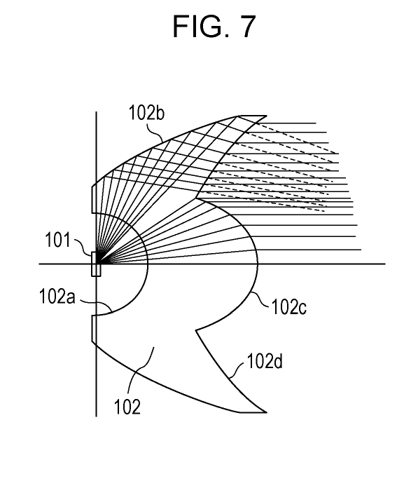

In the case of a collimator lens disclosed in Domestic Re-publication of PCT International Publication for Patent Application No. WO2008/069143, as illustrated in FIG. 7, the lens has the above-described convex lens shape. However, an exit surface of a portion refracting a light beam with a small angle formed with an optical axis is an ellipsoidal surface 102c with a convex shape, but an incident side is a concave spherical surface 102a. Therefore, in the center portion including the optical axis, it is necessary to obtain a collecting effect only on the exit side, and thus the collecting efficiency of the convex lens may deteriorate. Accordingly, there is a restriction in design because it is necessary to increase the curvature of the ellipsoidal surface 102c with a convex shape on the exit side. Alternatively, the focal distance of the ellipsoidal surface 102c with the convex shape on the exit side increases. Therefore, when the collimator lens is mounted, there is a problem that the size of the scanning module 9 increases.

In FIG. 7, reference numeral 101 denotes a light source, reference numeral 102 denotes a collimator lens, reference numeral 102b denotes an ellipsoidal surface totally reflecting light from the light source 101, and reference numeral 102d denotes an ellipsoidal surface refracting the light totally reflected by the ellipsoidal surface 102b.

In the embodiment, as illustrated in FIG. 5, as indicated by an arrow “R1”, an incident surface in the center portion including the optical axis of the objective lens 17 is configured as the incident side convex surface 28a with the convex shape. On the other hand, as indicated by an arrow “R2”, an exit surface is configured as the exit side convex surface 28b with the convex shape. Thus, since the convex surfaces on both sides of the center portion of the lens element 17 are the incident surface and the exit surface, the collecting efficiency can be easily improved. Accordingly, it is not necessary to particularly increase the curvature of the exit side convex surface 28b on the exit side. Further, the focal distance of the exit side convex surface 28b on the exit side does not increase, and thus the size of the scanning module 9 does not increase.

When the fluorescence a at a small emission angle among the fluorescence emitted from the sample 16 is collected by the center portion including the optical axis of the objective lens 17 and the fluorescence b at a large emission angle is collected by the peripheral portion of the objective lens 17, it is preferable to clearly separate an optical path of the light incident on the incident surface of the center portion and an optical path of the light incident on the incident surface of the peripheral portion from each other in the objective lens 17.

In the case of the collimator lens disclosed in Domestic Re-publication of PCT International Publication for Patent Application No. WO2008/069143, the light of the center portion which is incident on the spherical surface 102a and reaches the ellipsoidal surface 102c with the convex portion is not clearly separated from the light of the peripheral portion which is incident on the spherical surface 102a and reaches the ellipsoidal surface 102b with the convex shape. Therefore, there is light incident on the spherical surface 102a that reaches the concave ellipsoidal surface 102d, that is totally reflected, and that becomes stray light.

In the embodiment, as illustrated in FIG. 5, the form of the incident surface in the objective lens 17 in the center portion including the optical axis is formed as the incident side convex surface 28a with the convex shape, as indicated by the arrow “R1” and a peripheral portion (the cylindrical body 29) of the center portion is formed as the incident side end surface 29a with the convex shape as indicated by an arrow “R3”. Thus, the center portion and the peripheral portion on the incident surface are formed by different curved surfaces and a narrow portion with a concave shape (valley shape) is formed in the boundary of the center portion and the peripheral portion. Accordingly, the center portion and the peripheral portion on the incident surface are clearly separated from each other.

Therefore, the light incident on the incident side convex surface 28a of the center portion (the convex lens portion 28) is refracted to the side of the optical axis of the objective lens 17. On the other hand, the light incident on the incident side end surface 29a of the peripheral portion (the cylindrical body 29) is refracted to the side of the outer circumferential surface 29b located further away from the optical axis of the objective lens 17. Thus, since the refraction direction of the light incident on the incident side convex surface 28a is considerably different from the refraction direction of the light incident on the incident side end surface 29a, the light incident on the incident side convex surface 28a of the center portion and the light incident on the incident side end surface 29a of the peripheral portion can be prevented from reaching a surface between the exit side convex surface 28b of the center portion and the outer circumferential surface 29b of the peripheral portion, and thus the light reaching a surface between the exit side convex surface 28b and the outer circumferential surface 29b can be prevented from becoming stray light.

The shapes of the incident side convex surface 28a and the incident side end surface 29a are set such that the optical path of the light incident on the incident side convex surface 28a of the center portion on the incident surface of the objective lens 17 and the optical path of the light incident on the incident side end surface 29a of the peripheral portion do not intersect each other in the objective lens 17.

Accordingly, all of the light incident on the incident side convex surface 28a of the center portion reaches the exit side convex surface 28b with the convex shape which is an exit surface. On the other hand, all of the light incident on the incident side end surface 29a of the peripheral portion reaches the outer circumferential surface 29b which is a reflection surface. As a result, stray light is not generated due to light that is incident on the incident surface of the objective lens 17 and that reaches surfaces other than the exit side convex surface 28b and the outer circumferential surface 29b.

The exit surface in the center portion of the objective lens 17 is configured as the exit side convex surface 28b with the convex shape, as indicated by the arrow “R2” in FIG. 5. Accordingly, in the center portion of the objective lens 17, the fluorescence a at a small emission angle among the fluorescence emitted from the sample 16 can be effectively collected toward the detector 27 by combination of the incident side convex surface 28a which is the incident surface and the exit side convex surface 28b which is the exit surface.

The incident surface in the peripheral portion of the objective lens 17 is configured as the incident side end surface 29a with the convex shape, as described above. The incident surface of the objective lens 17 is configured such that the incident side convex surface 28a having the convex shape in the center portion and the incident side end surface 29a having the convex shape in the peripheral portion are formed as individual convex shapes that are adjacent to each other with a narrow portion having a concave shape (valley shape) as the boundary therebetween. Accordingly, the collecting effect by the convex lens can be obtained on the incident surface even in the peripheral portion, and thus it is possible to reduce an irradiation area in which the light incident from the incident side end surface 29a of the peripheral portion irradiates the outer circumferential surface 29b. As a result, the length in the optical axis direction of the outer circumferential surface 29b in the objective lens 17 can be shortened, and thus miniaturization of the entire objective lens 17 can also be achieved.

The reflection surface in the peripheral portion of the objective lens 17 is formed as the outer circumferential surface 29b with the convex shape toward the outside of the objective lens 17, as indicated by an arrow “R4” in FIG. 5. Thus, from the fact that the outer circumferential surface (reflection surface) 29b has a convex shape toward the outside, the outer circumferential surface 29b can be considered to be a concave surface mirror when viewed from the light inside the objective lens 17, and thus the outer circumferential surface 29b can collect the reflected light using the principle of a concave surface mirror.

That is, the peripheral portion in the objective lens 17 has two-step collecting functions of refracting and collecting the incident light with the incident side end surface 29a having the convex shape like a convex lens and further reflecting and collecting the light with the outer circumferential surface 29b having the convex shape like a concave surface mirror. Accordingly, the collecting property can be improved more than when one of the collecting functions is performed alone.

The incident side end surface 29a in the peripheral portion of the objective lens 17 is formed so that the light incident from the incident side end surface 29a satisfies a total reflection condition with respect to the outer circumferential surface 29b.

Accordingly, the light incident from the incident side end surface 29a in the peripheral portion of the objective lens 17 can be totally reflected by the outer circumferential surface 29b and can travel toward the exit surface through the peripheral portion.

In the embodiment, the incident light from the incident side end surface 29a is configured to be totally reflected by the outer circumferential surface 29b of the cylindrical body 29 in the peripheral portion. However, the invention is not limited to total reflection, and simple reflection may be realized. That is, a metal reflection film may be formed on the outer circumferential surface 29b so that light is reflected by the metal reflection film.

As described above, by causing the outer circumferential surface 29b of the cylindrical body 29 to totally reflect or reflect the fluorescence at a large emission angle which does not enter the convex lens portion 28 among the fluorescence emitted from the sample 16, the objective lens 17 can collect the light at a large emission angle which may not be collected by a normal convex lens. Therefore, it is possible to increase the sensitivity of the detector 27.

It is possible to form the lens element compactly compared to a case of a normal convex lens in which the same NA as that of the objective lens 17 of the photodetection apparatus 1 is realized.

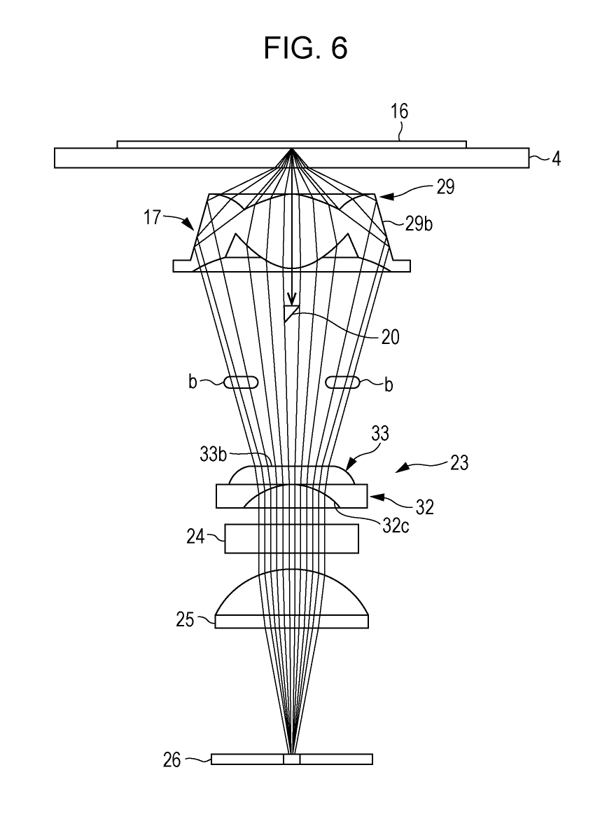

FIG. 6 is a diagram illustrating beams of fluorescence being emitted from the sample 16 and passing through the objective lens 17 to the second lens 25. In FIG. 6, since an interference filter in which cutoff is sharp is used as the wavelength filter 24, it is necessary to convert the incident light on the wavelength filter 24 into parallel light. Accordingly, the fluorescence passing through and collected by the objective lens 17 is converted into a state similar to parallel light by the first lens 23 and is made to be incident on the wavelength filter 24. Here, the fluorescence can also be converted into parallel light by the objective lens 17. However, in this case, the beam diameter of the fluorescence may increase, and thus the sizes of the optical elements downstream of the first lens 23 may increase.

Accordingly, as described above, by using the objective lens 17 that includes the convex lens portion 28 in the center portion and the truncated conic cylindrical body 29 in the peripheral portion of the convex lens portion 28, miniaturization of the optical elements, that is, the first lens 23, the wavelength filter 24, and the second lens 25, can be achieved, and thus miniaturization and weight reduction of the scanning module 9 can be achieved.

In the above description, the case in which fluorescence emitted from the sample 16 as a result of irradiation with excitation light from the light source 18 is detected has been exemplified. The light emitted from the sample 16 also includes reflected or scattered light as well as the fluorescence. That is, when a transfer support in which an organism-derived substance labeled with a reflection or absorption substance is distributed is set as the sample 16, high-intensity light (reflected or scattered light) of the same wavelength as that of the excitation light is emitted from the sample 16 labeled with the reflection or absorption substance as a result of irradiation with excitation light from the light source 18.

As described above, in the embodiment, as a result of the irradiation with excitation light emitted from the light source 18 and passing through the excitation light transmission portion of the objective lens 17, the light emitted isotropically from substantially one point of the sample 16 is collected by the objective lens 17 and is detected by the detector 27.

The objective lens 17 is formed so as to include the convex lens portion 28 in the center portion and the truncated conic cylindrical body 29 in the peripheral portion of the convex lens portion 28. Accordingly, by totally reflecting or reflecting the light b at a large emission angle which does not enter the convex lens portion 28 among the light emitted from the sample 16 and collecting the light with the outer circumferential surface 29b of the cylindrical body 29, it is possible to efficiently collect the light at a large emission angle which may not be collected by a normal convex lens. As a result, a light collecting ratio of the light can be improved, the S/N can be prevented from deteriorating due to the presence of light which is blocked by the reflective mirror 20 disposed on the optical axis of the objective lens 17 and is not detected by the detector 27, and thus a photodetection apparatus with high sensitivity can be realized.

Accordingly, in the embodiment, the objective lens 17 can be configured to be miniaturized more than when the light b at a large emission angle is collected by a normal convex lens with a high NA. Since the objective lens 17 collects the light from the sample 16 and the light is incident on the first lens 23, the optical elements such as the first lens 23, the wavelength filter 24, and the second lens 25 installed on the optical path along which the light is guided to the detector 27 can also be miniaturized.

By miniaturizing the optical elements such as the objective lens 17, the first lens 23, the wavelength filter 24, and the second lens 25, it is possible to reduce the weight of the scanning module 9 on which the light irradiation optical system and the detection optical system are mounted. Accordingly, the configuration of the scanning mechanism can be simplified and the weight of the scanning mechanism can be reduced, so that high-speed scanning of the scanning module 9 can be realized. Accordingly, it is possible to detect a two-dimensional light distribution at a plurality of different positions in the sample 16 at a high speed.

In the embodiment, the objective lens 17 has a shape concentric with respect to a central axis which is the optical axis, as illustrated in FIG. 4. The central axis overlaps with at least a part of the excitation light transmission portion through which the excitation light reflected by the reflective mirror 20 passes. Therefore, stronger excitation energy can be given to the sample 16 than when performing a method of irradiating the sample with excitation light through a dichroic mirror, and thus the S/N of a signal (image information) photoelectrically detected by the detector 27 can be improved. The excitation light transmission portion can be provided near the optical axis, the excitation light can be caused to be incident substantially vertically with respect to the center portion of the objective lens 17, and thus the excitation light can easily be caused to be incident.

Here, the excitation light transmission portion in the objective lens 17 may have any shape as long as the excitation light transmission portion has a function of transmitting the excitation light from the light source 18. For example, even when the excitation light transmission portion has no different characteristics from those of the peripheral portion of the excitation light transmission portion, there is no problem. That is, even when there are no characteristics such as differences between the lens curvature of the excitation light transmission portion and the lens curvature of the peripheral portion and there are no clear structural differences from the peripheral portion or there is no clear boundary therebetween, the excitation light transmission portion may be used as long as the excitation light from the light source 18 can be transmitted at the time of actual use.

In the embodiment, the second lens 25 is located as the intermediate lens element between the objective lens 17 and the detector 27. The light collected by the objective lens 17 is further point-collected by the second lens 25 so that the collection position is on the detection surface of the detector 27.

In order to improve the photodetection efficiency of the photodetection apparatus 1, it is necessary to collect the light so that the diameter of a collecting spot becomes very small on the detection surface of the detector 27. However, it is difficult to perform point-collecting with only the objective lens 17 with the above-described configuration. For example, even when the distance between the objective lens 17 and the sample 16 is slightly changed, the diameter of the spot on the detection surface of the detector 27 becomes very large, and thus a problem occurs in that the detection efficiency deteriorates. Accordingly, in the embodiment, the light radially emitted from the sample 16 is first loosely collected in a state similar to parallel light by the objective lens 17 and is subsequently point-collected onto the detection surface of the detector 27 by the second lens 25. By doing so, the photodetection efficiency can be improved.

In the embodiment, the wavelength filter 24 blocking the light of the component with the same wavelength as the wavelength of the excitation light from the light source 18 is located between the objective lens 17 and the second lens 25. Further, stray light with the same wavelength as the wavelength of the excitation light which comes from the light source 18 and is to be incident on the detector 27 is blocked. Accordingly, the detector 27 can efficiently detect the fluorescence.

As described above, the photodetection apparatus includes: the objective lens element 17 that collects light from the measurement object 16; and the photodetection element 27 that detects the light collected by the objective lens element 17. The objective lens element 17 includes the center portion 28 that collects the light through refraction and the peripheral portion 29 located around the center portion 28 to collect the light through reflection.

In the foregoing embodiment, the objective lens element 17 collecting the light from the measurement object 16 includes the peripheral portion 29 collecting the light through reflection on the outer circumference of the center portion 28 corresponding to a normal convex lens collecting the light through refraction. Accordingly, light at a large emission angle which may not be collected in a normal convex lens can also be collected, and thus collecting efficiency can be improved and the sensitivity of the photodetection element 27 can be increased. Therefore, in order to improve the S/N of a photoelectrically detected signal (image information), as in the image reading device of the related art, the diameter of the objective lens element 17 can be reduced more than when the convex lens having the same NA as the objective lens element 17 is used as an objective lens.

Since the objective lens element 17 collects the light from the measurement object 16 and the light is incident on the photodetection element 27, the diameters of the optical elements and the photodetection element 27 downstream of the objective lens element 17 can be reduced, and thus the detection optical system can be configured compactly so that scanning can be performed at a high speed.

In the photodetection apparatus according to an embodiment, the light from the measurement object 16 is light that is radially emitted from substantially one point on the measurement object 16. The objective lens element 17 collects the light that is radially emitted from the substantially one point on the measurement object 16 to the photodetection element 27.

According to the embodiment, even weak light radially emitted from substantially one point on the measurement object 16 is collected with high collecting efficiency by the objective lens element 17 and is collected onto the photodetection element 27. Therefore, the light can be detected with high sensitivity by the photodetection element 27.

The photodetection apparatus according to an embodiment further includes the light source 18 that irradiates the measurement object 16 with light. The objective lens element 17 includes the light transmission portion that transmits the light from the light source 18. The light from the light source 18 is made to pass through the light transmission portion of the objective lens element 17 so as to irradiate the measurement object 16.

According to the embodiment, the light from the light source 18 passes through the light transmission portion of the objective lens element 17 and the measurement object 16 is irradiated with the light. Therefore, stronger excitation energy can be given to the measurement object 16 than when performing a method of irradiating the measurement object 16 with the excitation light through a dichroic mirror, and thus the S/N of a signal (image information) photoelectrically detected by the photodetection element 27 can be improved.

In the photodetection apparatus according to an embodiment, the objective lens element 17 has a shape concentric with the optical axis. The optical axis passes through at least a part of the light transmission portion.

According to the embodiment, the light transmission portion can be provided near the optical axis in the objective lens element 17 having a shape concentric with the optical axis. Accordingly, the light from the light source 18 can be caused to be incident substantially vertically with respect to the center portion 28 of the objective lens element 17, and thus the light can easily be caused to be incident.

The photodetection apparatus according to an embodiment further includes the wavelength filter 24 that is located between the objective lens element 17 and the photodetection element 27 and reduces the light with substantially the same wavelength as the wavelength of the light from the light source 18. The wavelength filter 24 reduces a light component with substantially the same wavelength as the wavelength of the light from the light source 18 among the light collected by the objective lens element 17 and irradiates the photodetection element 27 with the light.

According to the embodiment, the wavelength filter 24 reduces the light component with substantially the same wavelength as the wavelength of the light from the light source 18. Therefore, stray light with substantially the same wavelength as the wavelength of the light coming from the light source 18 and that is incident on the photodetection element 27 can be blocked by the wavelength filter 24. Accordingly, the photodetection element 27 can efficiently detect the fluorescence.

The photodetection apparatus according to an embodiment further includes the intermediate lens element 25 that is located between the objective lens element 17 and the photodetection element 27. The intermediate lens element 25 further collects the light collected by the objective lens element 17 to the photodetection element 27.

In order to improve photodetection efficiency in the detector 27, it is necessary to collect the light so that the diameter of a collecting spot becomes very small on the detection surface of the detector 27.

According to the embodiment, the light collected by the objective lens element 17 is collected onto the photodetection element 27 by the intermediate lens element 25. Accordingly, the light radially arriving from the sample 16 is loosely collected in a state similar to parallel light by the objective lens 17 and is subsequently point-collected onto the photodetection element 27 by the intermediate lens element 25. Therefore, the photodetection efficiency can be improved.

In the photodetection apparatus according to an embodiment, the center portion 28 of the objective lens element 17 includes the incident side convex surface 28a on which the light from the measurement object 16 is incident and which has the convex curved surface shape toward an outside in the optical axis direction, and the exit side convex surface 28b from which the light from the incident side convex surface 28a is emitted and which has the convex curved surface shape toward the outside in the optical axis direction. The peripheral portion 29 of the objective lens element 17 includes the incident side end surface 29a on which the light from the measurement object 16 is incident, the outer circumferential surface 29b that internally reflects the light from the incident side end surface 29a, and the exit side end surface 29c from which the light internally reflected by the outer circumferential surface 29b is emitted. The concave boundary portion is formed at a boundary between the incident side convex surface 28a in the center portion 28 and the incident side end surface 29a in the peripheral portion 29.

According to the embodiment, in the center portion 28 of the objective lens element 17, the incident surface is configured as the incident side convex surface 28a with the convex shape and the exit surface is configured as the exit side convex surface 28b with the convex shape. Therefore, the collecting efficiency can be easily improved. Accordingly, it is not necessary to particularly increase the curvature of the exit side convex surface 28b on the exit side. Further, the focal distance of the exit side convex surface 28b on the exit side does not increase, and thus the size of the scanning module 9 does not increase.

On the incident surface, the concave boundary portion is formed at the boundary between the incident side convex surface 28a in the center portion 28 and the incident side end surface 29a in the peripheral portion 29. The refraction direction of the light incident on the incident side convex surface 28a is considerably different from the refraction direction of the light incident on the incident side end surface 29a, and thus the center portion 28 and the peripheral portion 29 are clearly separated on the incident surface. Accordingly, the light incident on the incident side convex surface 28a and the light incident on the incident side end surface 29a can be prevented from reaching a surface between the exit side convex surface 28b and the outer circumferential surface 29b, and thus the light reaching a surface between the exit side convex surface 28b and the outer circumferential surface 29b can be prevented from becoming stray light.

In the photodetection apparatus according to an embodiment, the incident side convex surface 28a in the center portion 28 and the incident side end surface 29a in the peripheral portion 29 in the objective lens element 17 have a shape such that the optical path of the light incident from the incident side convex surface 28a and the optical path of the light incident from the incident side end surface 29a are separated from each other by the concave boundary portion and do not intersect each other.

According to the embodiment, the optical path of the light incident from the incident side convex surface 28a does not interest the optical path of the light incident from the incident side end surface 29a. As a result, all of the light incident on the incident side convex surface 28a of the center portion 28 reaches the exit side convex surface 28b with the convex shape which is the exit surface. On the other hand, all of the light incident on the incident side end surface 29a of the peripheral portion 29 reaches the outer circumferential surface 29b which is the reflection surface.

Accordingly, stray light caused by light that is incident on the incident surface and that reaches surfaces other than the exit side convex surface 28b and the outer circumferential surface 29b is prevented from occurring.

In the photodetection apparatus according to an embodiment, the incident side end surface 29a in the peripheral portion 29 of the objective lens element 17 has the convex curved surface shape toward the outside.

According to the embodiment, the incident side end surface 29a in the peripheral portion 29 has a convex curved surface shape toward the outside. Accordingly, the collecting effect by the convex lens can be obtained on the incident surface even in the peripheral portion 29, and thus it is possible to reduce an irradiation area of the light incident from the incident side end surface 29a and the light with which the outer circumferential surface 29b is irradiated. As a result, the length in the optical axis direction of the outer circumferential surface 29b can be shortened, and thus miniaturization of the entire objective lens element 17 can also be achieved.

In the photodetection apparatus according to an embodiment, the outer circumferential surface 29b in the peripheral portion 29 of the objective lens element 17 has the convex curved surface shape toward the outside.

According to the embodiment, the outer circumferential surface (reflection surface) 29b of the objective lens element 17 has a convex curved surface shape toward the outside, and thus the outer circumferential surface 29b can be considered to be a concave surface mirror when viewed from the light inside the objective lens element 17. Accordingly, the outer circumferential surface 29b can collect the reflected light using the principle of a concave surface mirror.

That is, the peripheral portion 29 in the objective lens element 17 has two-step collecting functions of refracting and collecting the incident light by the incident side end surface 29a with the convex shape like a convex lens and further reflecting and collecting the light by the outer circumferential surface 29b with the convex shape like a concave surface mirror. Accordingly, the collecting property can be improved more than when one of the collecting functions is solely performed.

### REFERENCE SIGNS LIST

1 PHOTODETECTION APPARATUS

4 SAMPLE TABLE

5 PC

6 SCANNING STAGE

9 SCANNING MODULE

16 SAMPLE

17 OBJECTIVE LENS

18 LIGHT SOURCE

20 REFLECTIVE MIRROR

23 FIRST LENS

24 WAVELENGTH FILTER

25 SECOND LENS

26 PINHOLE

27 DETECTOR

28 CONVEX LENS PORTION (CENTER PORTION)

28a INCIDENT SIDE CONVEX SURFACE

28b EXIT SIDE CONVEX SURFACE

29 CYLINDRICAL BODY (PERIPHERAL PORTION)

29a INCIDENT SIDE END SURFACE

29b OUTER CIRCUMFERENTIAL SURFACE

29c EXIT SIDE END SURFACE

1. A photodetection apparatus comprising:
an objective lens element that collects light from a measurement objects; and
a photodetection element that detects the light collected by the objective lens element,
wherein the objective lens element includes a center portion that collects the light through refraction and a peripheral portion located around the center portion to collect the light through reflection.

2. The photodetection apparatus according to claim 1,
wherein the light from the measurement object is light that is radially emitted from substantially one point on the measurement object, and
wherein the objective lens element collects the light that is radially emitted from the substantially one point on the measurement object to the photodetection element.

3. The photodetection apparatus according to claim 1, further comprising:
a light source that irradiates the measurement object with light,
wherein the objective lens element includes a light transmission portion that transmits the light from the light source, and
wherein the light from the light source is made to pass through the light transmission portion of the objective lens element so as to irradiate the measurement object.

4. The photodetection apparatus according to claim 3,
wherein the objective lens element has a shape concentric with an optical axis, and
wherein the optical axis passes through at least a part of the light transmission portion.

5. The photodetection apparatus according to claim 3, further comprising:
a wavelength filter that is located between the objective lens element and the photodetection element and reduces light with substantially the same wavelength as a wavelength of the light from the light sourced,
wherein the wavelength filter reduces a light component with substantially the same wavelength as the wavelength of the light from the light source among the light collected by the objective lens element and irradiates the photodetection element with the light.

6. The photodetection apparatus according to claim 1, further comprising:
an intermediate lens element that is located between the objective lens element and the photodetection element,
wherein the intermediate lens element further collects the light collected by the objective lens element to the photodetection element.

7. The photodetection apparatus according to claim 1,
wherein the center portion of the objective lens element includes
an incident side convex surface on which the light from the measurement object is incident and which has a convex curved surface shape toward an outside in an optical axis direction, and
an exit side convex surface from which the light from the incident side convex surface is emitted and which has a convex curved surface shape toward the outside in the optical axis direction,
wherein the peripheral portion of the objective lens element includes
an incident side end surface on which the light from the measurement object is incident,
an outer circumferential surface that internally reflects the light from the incident side end surface, and
an exit side end surface from which the light internally reflected by the outer circumferential surface is emitted, and
wherein a concave boundary portion is formed at a boundary between the incident side convex surface in the center portion and the incident side end surface in the peripheral portion.

8. The photodetection apparatus according to claim 7, wherein the incident side convex surface in the center portion and the incident side end surface in the peripheral portion in the objective lens element have a shape such that an optical path of the light incident from the incident side convex surface and an optical path of the light incident from the incident side end surface are separated from each other by the concave boundary portion and do not intersect each other.

9. The photodetection apparatus according to claim 7, wherein the incident side end surface in the peripheral portion of the objective lens element has a convex curved surface shape toward the outside.

10. The photodetection apparatus according to claim 7, wherein the outer circumferential surface in the peripheral portion of the objective lens element has a convex curved surface shape toward the outside.
